(19) United States
(12) Patent Application Publication
(10) Pub. No.: US 2005/0067206 A1
(43) Pub. Date: Mar. 31, 2005

(54) Personal motorized vehicle having an adjustable wheelbase assembly

(76) Inventors: Edwin L. Trautman, Akron, OH (US); Pierre Leneveu, St. Laurent (CA)

Correspondence Address: Roetzel & Andress, 222 South Main Street, Akron, OH, 44308, US

(21) Appl. No.: 10/830,593

(22) Filed: Apr. 23, 2004

Related U.S. Application Data
(60) Provisional application No. 60/464,786, filed on Apr. 23, 2003.

(51) Int. Cl. B62K 13/00; B62D 61/02; B62M 7/00; B62D 61/12; B62K 11/00

(52) U.S. Cl. 180/209

(57) ABSTRACT

The present invention is directed to an adjustable wheelbase personal mobility vehicle, which includes a wheelbase assembly including a front wheel assembly and a rear wheel assembly; at least one front wheel mounted relative to the front wheel assembly for controlling the direction of movement of said personal mobility vehicle; drive wheels mounted relative to the rear wheel assembly for driving the vehicle; a seat connected to the rear wheel assembly for supporting an operator; and a mechanism for retracting and extending the wheel base assembly which is a glide and channel assembly wherein the sides of the front wheel provide a channel and the rear wheel assembly has at least one glide on each side whereby the front wheel assembly is supported by the glides, which provide the support via the channels, so as to allow the scooter to extend or retract axially to extend lengthwise over the glides, and thus to vary the length of the vehicle.

### BACKGROUND OF THE INVENTION

The present invention relates to a personal motorized vehicle having a novel adjustable wheel base assembly which permits the vehicle frame to be extended and retracted by the operator of the vehicle along the axis formed by the traditional placement of the steering column and operator seat, e.g., the axis along which the vehicle moves forward or backward (the Forward/Backward Axis), or in other words, lengthwise or longitudinal in orientation.

With the increase of the popularity of personal mobility vehicles for a more aging population, there is a desire for increased flexibility and configuration of the personal mobility vehicle. While a long wheel base, i.e., the length between the front wheel and the rear drive wheel, is desirable for stability in traversing, e.g., outdoor terrain, it presents a problem in more confined spaces. Therefore, a personal mobility vehicle having the characteristics of a long and short wheel base would be desirable to give the stability outdoors while providing a smaller turn radius and profile for negotiating smaller confined spaces indoors. Various means have been devised to provide personal mobility vehicles with a variable wheel base. For example, U.S. Pat. No. 6,530,445 to Flowers, et al., teaches a variable wheel base vehicle which uses a sleeve and shaft mechanism to allow the wheel base to be extended by having the shaft slidably received inside the sleeve. The flower design can use one or more of the shaft and sleeve arrangements in the vehicle. U.S. Pat. No. 5,996,716 to Montiglio et al. is directed to an adjustable wheelchair which uses a T-shaped rear frame, a T-shaped front frame and provides a telescopic connection between the frames to allow the wheelchair to be adjustable in length. A similar variable length concept is employed in U.K. Patent Application GB2,201,588 to Maynes. Additional examples of extendable wheel base mobility vehicles include U.S. Pat. No. RE33,675 to Young, U.S. Pat. No. 3,664,450 to Udden et al., U.S. Pat. No. 4,834,409 to Kramer, U.S. Pat. No. 5,848,658 to Pulver, and U.S. Pat. No. 6,273,206 to Bussinger.

### SUMMARY OF THE INVENTION

The present invention is the result of the discovery that a personal motorized vehicle which has an adjustable wheelbase, which provides improved stability, and which achieves it with a relatively simple design.

The present invention is directed to an adjustable vehicle base assembly which essentially comprises the wheelbase of the personal mobility vehicle. The wheelbase assembly includes a front assembly, which supports the front wheel, and a rear assembly, which supports the rear wheel or wheels. There are at least one front wheel mounted relative to the front wheel assembly for controlling the direction of movement of said personal mobility vehicle and drive wheels mounted relative to the rear wheel assembly for driving the vehicle. A seat is connected to the rear assembly or rear wheel assembly for supporting an operator. The mechanism employed for retracting and extending the wheel base assembly is a glide and channel assembly wherein the sides of the front wheel provide a channel and the rear wheel assembly has at least one glide on each side whereby the front wheel assembly is supported by the glides, which provide the support via the channels, so as to allow the scooter to extend or retract axially to extend lengthwise over the glides, and thus to vary the length of the vehicle. In this way, the channel that is part of the side wall of the front wheel assembly, i.e., the guide channels, will be carried by and traverse the slides carried by the rear wheel assembly to allow the scooter to extend or retract axially to extend lengthwise over the glides. The mating relationship of the slides and the guide channels facilitates the motion while providing support for the front wheel assembly.

### BRIEF DESCRIPTION OF THE DRAWINGS

For a fuller understanding of the nature and objects of the invention, reference should be made to the following detailed description of the invention taken in combination with the accompanying drawings in which:

FIG. 1 is a side elevational view of the adjustable vehicle in accordance with the present invention;

FIG. 2 a top view of the vehicle in FIG. 1, with part of the surface broken away to show the drive mechanism;

FIG. 3 is a cross-sectional view of taken along line 3-3 in FIG. 2;

FIG. 4 is an enlarged detail taken from the break-away section of FIG. 2;

FIG. 5 is an enlarged detail taken from FIG. 3 of one of the edges of the vehicle;

### DETAILED DESCRIPTION OF THE INVENTION

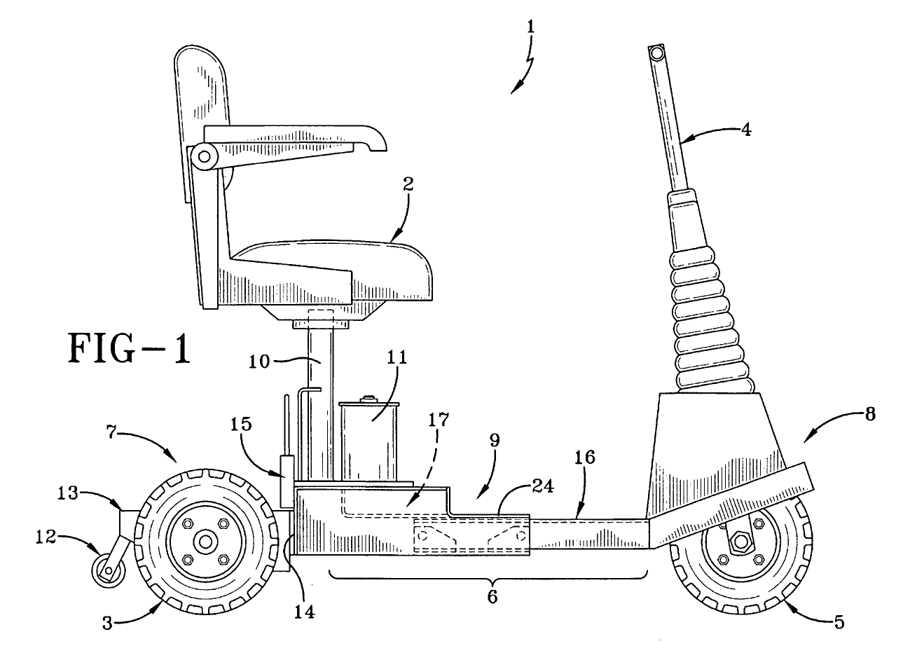

FIG. 1 is a side view of a personal motorized vehicle 1. Traditionally, personal motorized vehicles have at least two rear wheels and one or more front wheels located at the opposite, forward end of the vehicle. For the purpose of explaining the present invention, a personal motorized vehicle is illustrated with one front wheel, although the invention is not limited to the vehicle shown. The operator sits on a seat affixed to the vehicle frame. Typically, the seat is located toward the rear of the vehicle. The operator controls the direction of the motorized vehicle by means of handle bars attached to the steering column and by manipulating the controls attached or fixed to the steering column in such a manner so as to control the speed and braking of the vehicle.

The present invention is to an extendable/retractable forward frame sub-assembly and provides a means for extending and retracting same. This is accomplished via the unique mechanism provided by the present invention whereby the front wheel assembly is connected with the rear wheel assembly to form the wheel base assembly. While wheel base assembly of the invention will be discussed as two parts, in fact the rear wheels and drive could be made in a modular fashion in which the parts such as drive wheel, seat and battery or batteries are detachably attached to allow the vehicle to be taken apart for storage and/or transportation. Such modular vehicles are known in the art, such as U.S. Pat. No. 5,020,624 to Nesterick et al and U.S. Pat. No. 5,238,082 to Stegeman et al, the teachings of both being incorporated herein by reference.

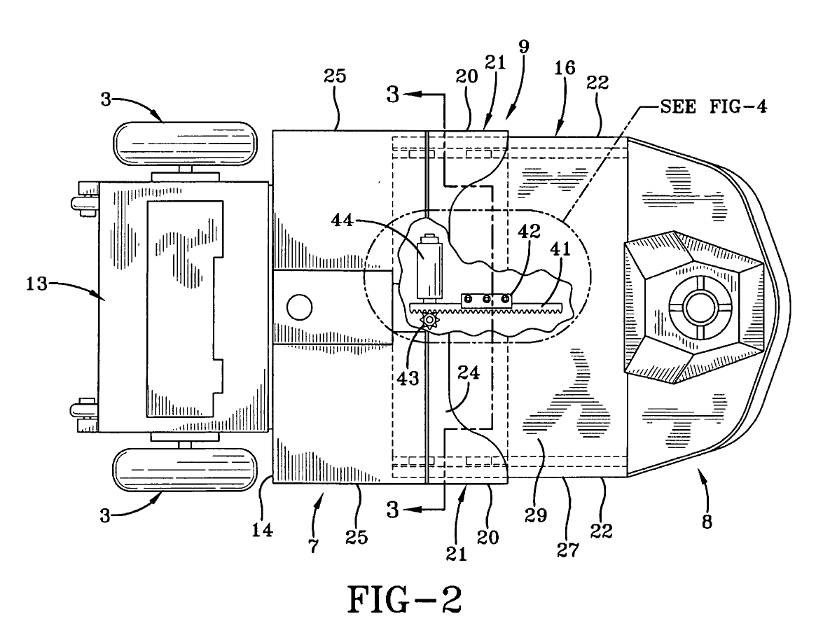

As shown in FIGS. 1 and 2 of the drawings, a traditional vehicle frame is typically constructed or designed to permit receiving or mounting a seat sub-assembly 2 upon which the operator would sit, and which can be removable from the seat support 10 for storing or transporting the vehicle and which would have an appropriate motor 11 to power the seat and provide an adjustable seat. The vehicle frame further permits the mounting or fixation of rear wheels 3 affixed to the vehicle frame parallel in orientation and aligned along the Forward/Backward Axis, a steering column 4 and a front wheel 5 which are interconnected and provide a means for and permit the operator of the vehicle to steer the personal motorized vehicle. The vehicle will also come equipped with a space for the battery or batteries 17, which may be removable for storage or transport, to provide power to the rear wheels via an appropriate drive system (not shown). For safety reasons, the vehicle may also come with a rear stabilizer safety wheel assembly 12.

The wheel base assembly 6 is not a rigid, one-piece frame but is rather comprised of at least two separate sub-assemblies, a rear wheel assembly 7 and an adjustable front wheel assembly 8, where the adjustable front wheel assembly 8 is not fixed in position relative to the rear wheel assembly 7. Rather, the front wheel assembly 8 is coupled with the rear wheel assembly 7 such that the adjustable front wheel assembly is permitted to move a defined distance relative to the rear wheel assembly 7 along the Forward/Backward Axis of the personal motorized vehicle e.g., longitudinally or lengthwise. At all times, the adjustable front wheel assembly 8 is connected to and integral with the rear wheel assembly 7 so that vehicular stability and integrity are preserved. As shown in FIG. 1, the rear wheels 3 and the drive box 13, which powers the rear wheels, may be detachably attached as part of the rear wheel assembly 7, for example, via a hook and latch assembly wherein the rear wheels are hooked on the rear end 14 of the rear wheels assembly 7. A latch mechanism 15 is shown generally in FIG. 1. When latched, the rear wheels and drive box are fixed as part of the rear wheel assembly. When unlatched, the vehicle is more compact and easy to store and transport.

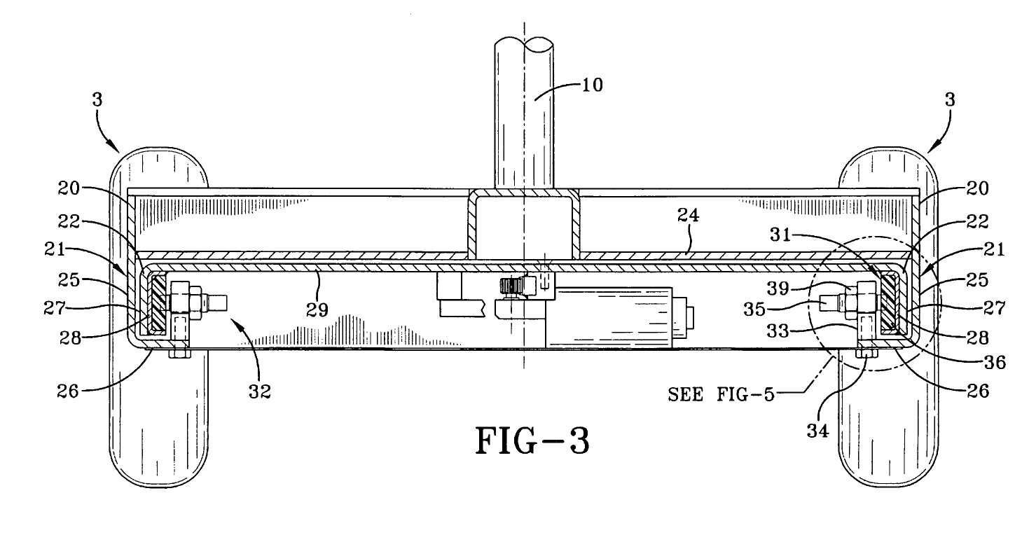

The adjustable wheel base mechanism of the present invention is disclosed in FIGS. 1, 2, 3 and 5 of the drawings, where a cross sectional view of a personal motorized vehicle shows of the adjustable front wheel assembly 8 housed within the front portion 9 of the rear wheel assembly 7.

The rear wheel assembly 7 is of sufficient size and shape to receive or envelop the rear portion 16 of the adjustable front wheel assembly 8. This is accomplished by having the sides 20 of the rear wheel assembly form channels 21 which support and envelop the sides 22 of the front wheel assembly 7, which also form channels 28. The channels 21 are formed by the front portion 9 of the rear wheel assembly 7, which makes up part of the floor 24 of the vehicle, the side walls 25, and a bottom wall 26. In nesting relationship to the channels 21 of the rear wheel assembly are the guide or glide channels 28 of the front wheel assembly. The sides 22 are defined by walls 27 which extend essentially perpendicular to the floor 29 which is the rear portion 16 of the front wheel assembly. The channels 28 are formed by attaching, e.g., by welding, aluminum channels to the side walls 27 and the floor 29 of the vehicle. The channel could be made in one piece by having a bottom wall similar to bottom wall 26. But, for manufacturing purposes it was preferred to use preformed aluminum channels and affix them to the floor and side walls rather than provide for the additional bottom wall. In either case, the top 46 and bottom 47 of the guide channel 28 of the front wheel assembly 8 are supported by the slides 31 attached to the rear wheel assembly 7. The vehicle base assembly is allowed to extend by traversing over the slides 31 while the glide channels 28 provide support and prevent the front wheel assembly 8 from moving out of the plane in which the front wheel assembly moves. Further, the configuration shown, i.e., with the channels facing inward, although preferred, could be varied by having the channels facing outward or having any similar configuration.

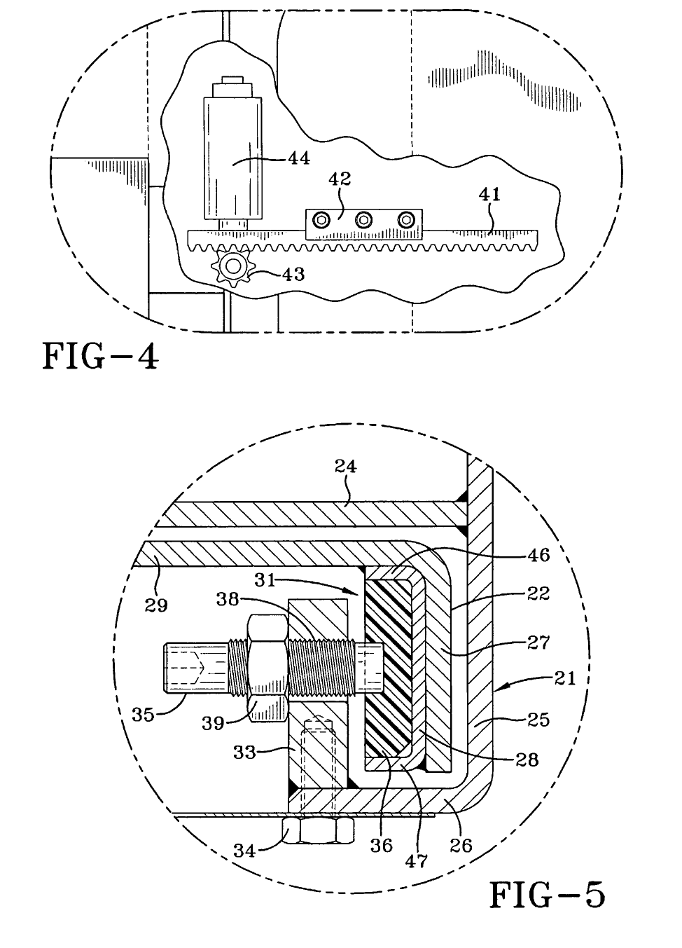

The front wheel assembly is supported by and slides inward and outwardly on fixed glides 31 which are held in place by a glide assembly 32 which is shown in FIG. 5 and which is affixed to the bottom wall 26 of the side channels 21 of the rear wheel assembly 7. The glides can be any structure which will provide support for the front wheel assembly and facilitate the sliding motion as the front wheel assembly extends and retracts. The preferred glides is a block which can by made from a plastic material, such as nylon, Teflon, or the like durable low friction material, or they could be composite glides such as where a durable composition, which could be metal or plastic is coated with a material which reduces friction and facilitates the sliding motion, such as nylon or Teflon. Alternatively, the glides could be made from wheels which will facilitate the sliding motion, or the like devices. As can be appreciated, the use of simple glides aids in the simplicity of the construction.

The glides are attached to the bottom wall 26 of the rear wheel assembly 7 via the glide assemblies 32. Although shown as attached to a bottom wall, the glides could be attached by the use of other devices such as brackets attached to the sides 20 of rear wheel assembly 7 or could be attached to other surfaces at the side of the rear wheel assembly. The vehicle can employ two or more glides. The number is not critical and may depend upon the length or distance the vehicle is intended to adjust. Further, there is nothing critical in the length or width of the glide blocks. As such, a single long glide block could be employed or several smaller (in length) glide blocks could be employed. In one example, the glide block was about nine inches (9″) long. The glide assemblies are affixed to and rest on the inside bottom wall of the rear wheel assembly. A support block 33 is attached to the bottom wall using appropriate fastener, such as a bolt 34. An adjustable pin 35 passes through block 33 and holds glide block 31 in place so that it will provide a bearing surface for the floor of the front wheel assembly. As shown the glide block 31 could be a nylon block 36. The support pin 35 is adjustable to move the glide 31 closer to or away from glide channel 28 so that glide 31 will be able to move in glide channel 28 and provide the necessary support. The pin 35 passes through an opening 38 in the block 33 and is held in position by an appropriate fastener, such as nut 39. In this way, the glide blocks 31 are fixed within the front portion 9 of the rear wheel assembly 7 so that the front wheel assembly 8 may slide or translate freely on the glide blocks 31.

The amount of space which the front wheel assembly 8 may extend or retract relative to the rear wheel assembly 7 along the Forward-Backward Axis may be defined by many means known in the art, but as shown in the attached drawings, this limitation is accomplished by the degree that the adjustable wheel base drive permits. That is the front wheel assembly and the rear wheel assembly are free to slide in their nesting relationship, but are linked to an adjustable wheel base drive which controls the extent to which the front and rear assemblies extend or retract. Thus, the adjustment will enable the overall length of the vehicle to be adjusted making it longer or shorter from the end of the drive box to the front tip of the front wheel assembly.

In the embodiment of the invention shown, the operator is provided a means for causing the extension or retraction of the retractable front assembly by a motor and rack and pinion gearing elements as described and shown on the drawings within. With reference to FIG. 4, a rack 41 is attached via an appropriate fastener 42 to the underside of the floor 29 portion of the front wheel assembly. A gear 43 driven by motor 44, such as an electric motor, is attached to the underside of the floor 24 of the rear wheel assembly so that the activation of the motor 44 will drive the gear 43 and cause the extension of and retraction of the front wheel assembly 3 relative to the rear wheel assembly 7. Other means for adjusting the length of the vehicle by extending and retracting the front wheel assembly can be, for example, worm gears, rack and pinion gears, spur gears, jack screw, scissors jack, hydraulic systems, pneumatic systems, belt driven systems, and the like and other systems or mechanics known in the art. Typically, the motor and gears would be controlled by the operator via controls located on the handlebars. Further, the system can include means for locking the relational position of the front wheel assembly and the rear wheel assembly so that, when the lock is in the on position, the front and rear assemblies cannot be adjusted, but when the lock is off or in the open setting, the positions can be adjusted.

The various sub-assemblies herein can be constructed out of ordinary materials including without limitation, plastics, metals, composites or the like, although aluminum is preferred. There is nothing critical in the selection of the materials other than it possesses mechanical and physical properties sufficient to provide the degree of structural integrity required for the application. Each of the foregoing types of materials as well as other materials known in the art are known to possess such properties. The motor 44 may be a motor of any type presently known in the art and may provide for example, multiple speeds of a retraction or extension.

Although the invention has been described in detail with particular reference to these preferred embodiments, other embodiments can achieve the same results. Variations and modifications of the present invention will be obvious to those skilled in the art and it is intended to cover in the appended claims all such modifications and equivalents. The entire disclosures of all references, applications, patents, and publications cited above are hereby incorporated by reference.

1. Claim 1 is an adjustable wheelbase personal mobility vehicle, comprising:
a wheelbase assembly comprising a front wheel assembly and a rear wheel assembly;
a front wheel pivotally-mounted relative to said front wheel assembly for controlling the direction of movement of said personal mobility vehicle;
plural drive wheels mounted relative to said rear wheel assembly for driving said vehicle;
a seat connected to said rear wheel assembly for supporting an operator; and
a mechanism for retracting and extending the wheel base assembly comprising a glide and channel assembly wherein the front wheel assembly has guide channels on each side of said front wheel assembly and the rear wheel assembly has at least one glide affixed on each side of said rear wheel assembly whereby said front wheel assembly is supported by said glides and is whereby the front wheel assembly will move in relationship with the rear wheel assembly to allow the scooter to extend or retract axially over said glides, and to vary the length of said vehicle.

2. The adjustable vehicle of claim 1, wherein the vehicle further includes an adjustable wheel base drive for moving the front wheel base assembly relative to said rear wheel base assembly to thereby vary the distance between said front wheel and said plural drive wheels.

3. The adjustable vehicle of claim 1, which further includes an adjustable wheel base drive for moving the front wheel base assembly relative to said rear wheel base assembly to thereby vary the distance between said front wheel and said plural drive wheels and said adjustable wheel base drive comprises a rack and pinion mechanism.

4. The adjustable vehicle of claim 1, which further includes an adjustable wheel base drive for moving the front wheel base assembly relative to said rear wheel base assembly to thereby vary the distance between said front wheel and said plural drive wheels and said adjustable wheel base drive comprises a jack screw.

5. The adjustable vehicle of claim 1, which further includes an adjustable wheel base drive for moving the front wheel base assembly relative to said rear wheel base assembly to thereby vary the distance between said front wheel and said plural drive wheels and said adjustable wheel base jack comprises a scissor jack.

6. The adjustable vehicle of claim 1, which further includes an adjustable wheel base drive for moving the front wheel base assembly relative to said rear wheel base assembly to thereby vary the distance between said front wheel and said plural drive wheels and said adjustable wheel base jack comprises a screw drive.

7. The adjustable vehicle of claim 1, wherein the adjustable wheel base mechanism includes a lock for locking the distance between said front wheel and said plural drive wheels when the lock is in a closed condition and for enabling the adjustment of the distance between the front wheel and said plural drive wheels when the lock is in an open position.

8. The adjustable vehicle of claim 1, wherein the vehicle further includes means for powering the drive wheels of said vehicle.

9. The adjustable vehicle of claim 1, where in the glide is a structure that provides support for the front wheel assembly and facilitates its sliding motion.

10. The adjustable vehicle of claim 1, wherein the glide is a nylon block.

11. The adjustable vehicle of claim 1, wherein the glide is a wheel.

12. The adjustable vehicle of claim 1, wherein the side walls of the rear wheel assembly forms channels and the slide channels are in nesting relationship therewith.

13. The adjustable vehicle of claim 1, wherein the side walls of the rear wheel assembly forms channels and the glides are attached to the bottom walls of channels of said rear wheel assembly.

14. The adjustable vehicle of claim 1, wherein the guide channels are attached to the side walls of the front wheel assembly.

15. The adjustable vehicle of claim 1, wherein the guide channels are formed by the side walls of the front wheel assembly.

16. The adjustable vehicle of claim 1, wherein the guides are adjustable in relationship to the guide channels.
